(19) United States
(12) Patent Application Publication
(10) Pub. No.: US 2018/0034320 A1
(43) Pub. Date: Feb. 1, 2018

(54) ROLLING BODY FOR TEMPORARILY ACCOMMODATING PRODUCTS OR GOODS FOR PURPOSES OF STORAGE AND/OR TRANSPORT, AND METHOD FOR OPERATING SUCH A ROLLING BODY

(71) Applicant: WRH WALTER REIST HOLDING AG, CH-8272 ERMATINGEN (CH)

(72) Inventors: Martin RUGE, Starrkirch-Wil (CH); Markus FELIX, Richterswil (CH)

(73) Assignee: WRH WALTER REIST HOLDING AG, CH-8272 ERMATINGEN (CH)

(21) Appl. No.: 15/658,648

(22) Filed: Jul. 25, 2017

(30) Foreign Application Priority Data
Jul. 28, 2016 (CH) 00986/16

(51) Int. Cl. H02J 50/10; H02J 7/02; H01M 2/10; H01M 10/46; H01M 10/44

(52) U.S. Cl. CPC H02J 50/10; H01M 10/465; H01M 10/44; H01M 2/1083; H02J 7/025; H01M 2220/20; H02S 20/30

(57) ABSTRACT

A rolling body (10a) for temporarily accommodating goods or products for purposes of storage and/or transport includes a shell (11) that encloses an inner space (12). A usable volume (13) for accommodating the goods is provided in the inner space (12). An autonomous mode of functioning is made possible in that an energy store (14) and an energy consumer (15) are additionally situated in the inner space (12), and the energy store (14) is connectable to the energy consumer (15) in order to deliver energy.

### CROSS-REFERENCE TO RELATED APPLICATIONS

Swiss Patent Application 00986/16, filed 28 Jul. 2016 the priority document corresponding to this invention, to which a foreign priority benefit is claimed under Title 35, United States Code, Section 119, and its entire teachings are incorporated, by reference, into this specification.

### BACKGROUND OF THE INVENTION

### Field of the Invention

The present invention relates to the field of transport and storage technology for products or goods, particularly to rolling bodies for temporarily accommodating goods or products for storage and/or transport. The present invention further relates to a method for operating such a rolling body.

### Discussion of Related Art

Rolling bodies for transport, storage, and packaging purposes are already known from the prior art.

Document WO 2014/191107 A1 discloses a transportable packaging unit, comprising a packaging content, a shell that surrounds the packaging content, and a connecting means that connects the packaging content to the shell, wherein the surrounding shell has the outer shape of a rollable body, and the connection means fixes the packaging content in the shell.

Also disclosed is a method for producing such a packaging unit, the packaging content being provided in a first step, the shell being provided in a second step, and the packaging content being introduced into the shell in a third step.

Document WO 2014/191108 A1 describes a transport holder for a transport object, comprising a rolling body having a ring-shaped rolling surface for rolling the rolling body on a base, and retaining means for holding the transport object in the rolling body in such a way that the rolling body encloses the transport object.

Also described is a method for transporting a transport object, the transport object being situated in such a transport holder at a departure point, the transport holder being transported from the departure point to a destination point, and the transport object being removed from the transport holder at the destination point.

Document WO 2014/191106 A1 describes a storage facility for a plurality of roller packaging units designed as rollable bodies, at least one storage device for storing multiple roller packaging units, an introduction device for receiving a roller packaging unit and for feeding this roller packaging unit into the storage device, a withdrawal device for rolling away a roller packaging unit stored in the storage device as a roller packaging unit that rolls away, and a control device for controlling the withdrawal device.

Also described is a storage system having multiple storage facilities of this type, rolling roller packaging units being suppliable to the storage facilities and/or removable therefrom via one or more rolling paths, in particular being suppliable to one or more storage facilities via at least one introduction rolling path, and/or removable from one or more storage facilities via at least one withdrawal rolling path.

The known rolling bodies rely upon external devices for the transport and introduction/withdrawal, provided that they are not set or kept in motion due to the force of gravity.

However, there are circumstances under which independent actions of the rolling bodies would be desirable.

There is a general need for improvements in this field.

### SUMMARY OF THE INVENTION

It is an object of the invention to provide a rolling body for temporarily accommodating goods or products for storage and/or transport that does not comprise disadvantages as mentioned above.

Particularly, such a rolling body should be able to autonomously carry out certain tasks in the context of its storage and transport capabilities.

It is also an object of the invention to provide corresponding methods for operating such a rolling body.

These and other objects are solved by a rolling body according to the invention, and a method for operating a rolling body according to the invention, as defined in the independent claims. Further advantageous embodiments are provided in the dependent claims.

The rolling body according to the invention for temporarily accommodating products or goods for purposes of storage and/or transport has a shell that encloses an inner space, a usable volume for accommodating the goods being provided in the inner space.

The rolling body is characterized in that an energy store and an energy consumer are additionally situated in the inner space, and the energy store is connectable to the energy consumer in order to deliver energy.

A first embodiment of the invention is characterized in that the energy store is designed for storing electrical energy, and the energy consumer consumes electrical energy. Primarily supercapacitors and accumulators are suited here as stores.

Means for supplying electrical energy from the outside, and which are connected to the energy store, may be provided on or in the rolling body.

The means for supplying electrical energy may have one or more induction coils. The induction may take place either by means of an alternating field in the manner of a transformer, or, for example under a constant magnetic field, via rotation of the induction coils in the manner of a generator.

In particular, multiple induction coils may be provided, which with their coil axis are oriented in different spatial directions.

However, the means for supplying electrical energy may also include externally accessible electrical contacts.

The electrical contacts may be distributed over the outer surface of the rolling body in order to improve the contact options and increase the likelihood of contact.

When the rolling body is spherical, for this purpose the electrical contacts may have a dome-shaped design.

However, it is also conceivable for the means for supplying electrical energy to include at least one light converter, which converts light irradiated from the outside into electrical energy.

Another embodiment of the invention is characterized in that the energy consumer includes a drive for autonomously moving the rolling body. In that case, the rolling body is not dependent on the force of gravity or external inputs for movement, and instead can move on its own, for example when it receives appropriate control commands from the outside via suitable communication channels.

For this purpose, the drive may include at least one electric motor that sets at east one drive element, for transmitting a torque, in rotation.

However, it is also conceivable for the drive to include at least one propeller unit.

According to another embodiment of the invention, the energy consumer may alternatively or additionally include means for data processing and/or data storage, and/or means for wireless communication and/or means for determining the position of the rolling body.

In addition, the rolling body may be equipped with active or passive information carriers or identification means such as a label, RFID, barcode, matrix code, color code, numerical code, hologram, or thermal code that may be read out and optionally read in by optical, magnetic, or radio-based means.

Motorized drives as well as electronic circuits, data memories, and/or processors for data processing, for example microprocessors, may be provided within the energy consumer. Furthermore, sensors for physical variables such as temperature or acceleration, and/or converters, for example piezoelectric converters, pneumatic converters, inductive converters, or electromagnetic converters, may be used in the rolling body for various tasks.

It is also possible to provide in the rolling body a data processing system, having a data memory, which receives, processes, and delivers product information concerning products that are introduced/transported in the rolling body, such as weight, use-by date, expiration date, production date, number/quantity information, state of ripeness, target temperature, temperature history, tracking number, transport order number, status information, and information concerning product geometry.

It is conceivable to carry out computing operations in the data processing system, using the product data and information concerning position, conveying path of the rolling body, and other external parameters, and as a result of these computing operations, to control electromechanical actuators which determine the further path of the rolling body in a storage or transport facility.

A method according to the invention for operating a rolling body according to the invention is characterized in that the energy store is replaceably housed in the rolling body, and that from time to time the energy store is replaced with a full energy store.

Another method according to the invention for operating a rolling body according to the invention is characterized in that the energy store is permanently housed in the rolling body, and that from time to time the energy store is charged from the outside.

The rolling body may have at least one induction coil, the rolling body being exposed to a magnetic field in order to charge the energy store. In particular, the magnetic field may be an alternating field.

However, the rolling body may also have externally accessible electrical contacts, the rolling body being electrically connected to electrical contacts in order to charge the energy store.

In particular, the rolling body may be moved into a charging station, provided for this purpose, in order to connect to the external electrical contacts.

However, the rolling body may also be electrically connected, and remain connected, to the external electrical contacts while rolling over a predefined route.

To be able to carry out an operation with the rolling bodies in the easiest possible manner and without interruptions, it is practical and advantageous to put the energy store under load only when actually necessary, and otherwise, for example when the rolling body is in a resting or waiting position in a warehouse, to preferably leave it free of load. It is useful here to provide a standby mode in the rolling body, in which the energy store is put under load only when necessary in order to keep the rolling body ready for a subsequent activation. Such an activation may take place via radio signals, for example, but requires that the corresponding electronics system in the rolling body at least be externally accessible.

### BRIEF DESCRIPTION OF SEVERAL VIEWS OF THE DRAWINGS

The present invention is explained in greater detail below based on preferred embodiments and with reference to the attached figures. Further advantages, features, preferences and aims of the invention are disclosed thereby.

FIG. 1 schematically shows a section of the basic configuration of one simple exemplary embodiment of a rolling body according to the invention;

FIG. 2 schematically shows a section of another exemplary embodiment of a rolling body according to the invention, with inductive charging of the energy store via a magnetic field;

FIG. 3 schematically shows a section of another exemplary embodiment of a rolling body according to the invention, with charging of the energy store by light irradiation;

FIG. 4 schematically shows a section of another exemplary embodiment of a rolling body according to the invention, with charging of the energy store by electrical connection to external electrical contacts;

FIG. 5 schematically shows a section of yet another exemplary embodiment of a rolling body according to the invention, with inductive charging of the energy store via a magnetic field by means of differently spatially oriented induction coils;

FIG. 6 schematically shows, in an outer view, another exemplary embodiment of the invention with dome-shaped electrical contact surfaces distributed over the surface;

FIG. 7 schematically shows a section of another exemplary embodiment of a rolling body according to the invention, with inductive charging of the energy store via a magnetic field by means of a movably supported induction coil;

FIG. 8 schematically shows a section of yet another exemplary embodiment of a rolling body according to the invention, with inductive charging of the energy store via a magnetic field by means of a movably supported induction coil, and having an inner roller drive in a (passive) downward rolling motion on a slope;

FIG. 9 schematically shows the rolling body from FIG. 8 in an (actively driven) upward rolling motion on a slope;

FIG. 10A schematically shows the transport of a rolling body according to the invention by means of a drone in a first step;

FIG. 10B schematically shows the transport of a rolling body according to the invention by means of a drone in a second step;

FIG. 10C schematically shows the transport of a rolling body according to the invention by means of a drone in a third step;

FIG. 11A schematically shows a suitable releasable coupling mechanism between the drone and the rolling body in a first step;

FIG. 11B schematically shows a suitable releasable coupling mechanism between the drone and the rolling body in a second step;

FIG. 12 schematically shows a schematic illustration of a charging station provided for charging a rolling body according to the invention;

FIG. 13 schematically shows a section of another exemplary embodiment of a rolling body according to the invention, having a pair of drive wheels for directionally controlled movement of the rolling body;

FIG. 14 schematically shows a section of another exemplary embodiment of a rolling body according to the invention, having multiple extendable propeller units for moving the rolling body in the manner of a drone;

FIG. 15 schematically shows a section of another exemplary embodiment of a rolling body according to the invention, in which, within the scope of the energy consumer, an automatically extendable (mechanical and/or electrical) coupling mechanism is provided; and

FIG. 16 schematically shows the wireless communication option for exchanging information and/or transmitting control commands between the rolling body and a communication center.

### DETAILED DESCRIPTION OF THE INVENTION

The examples provided hereinafter serve an improved illustration of the present invention, but are not suited for restricting the invention to the features disclosed herein.

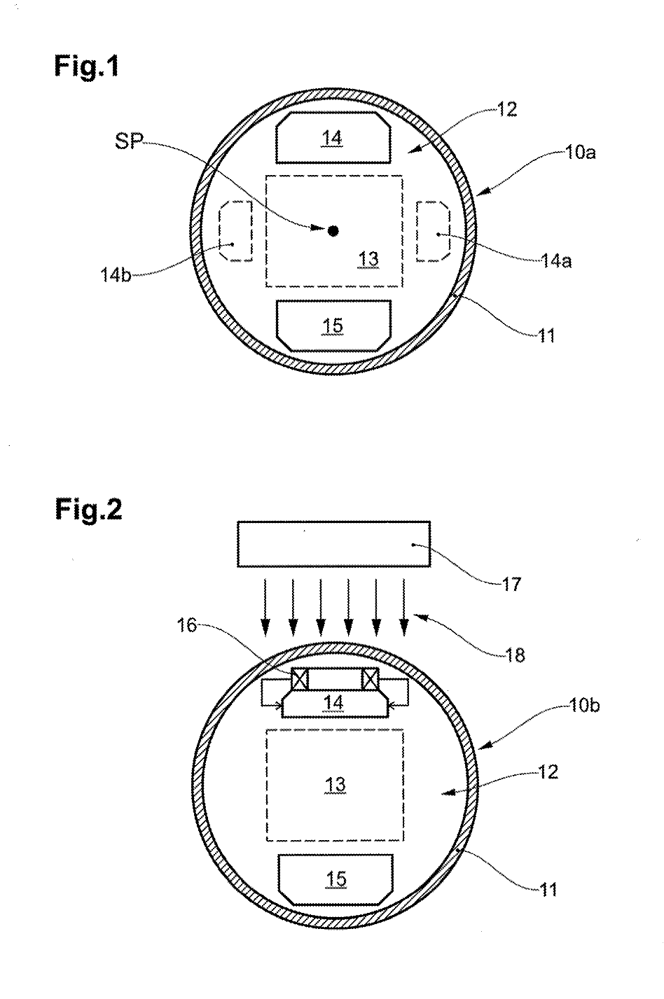

FIG. 1 shows a sectional illustration of the basic configuration of one simple exemplary embodiment of a rolling body according to the invention. In this example, the rolling body 10a in FIG. 1 has the shape of a sphere having a closed ball socket-shaped shell 11, which at a location not illustrated can be opened (for example, disassembled into two half spheres) in order to introduce an item into it for transport and/or storage, or to remove a stored item from it. The shell 11 surrounds a hollow inner space 12 in which a usable volume 13 is designated, preferably centrally, and used for accommodating a product or good. Unlike the illustration in FIG. 1, the shell 11 may also have an interrupted design, or may even have an open, grid-shaped structure, provided that this is compatible with the stored and transported goods or products.

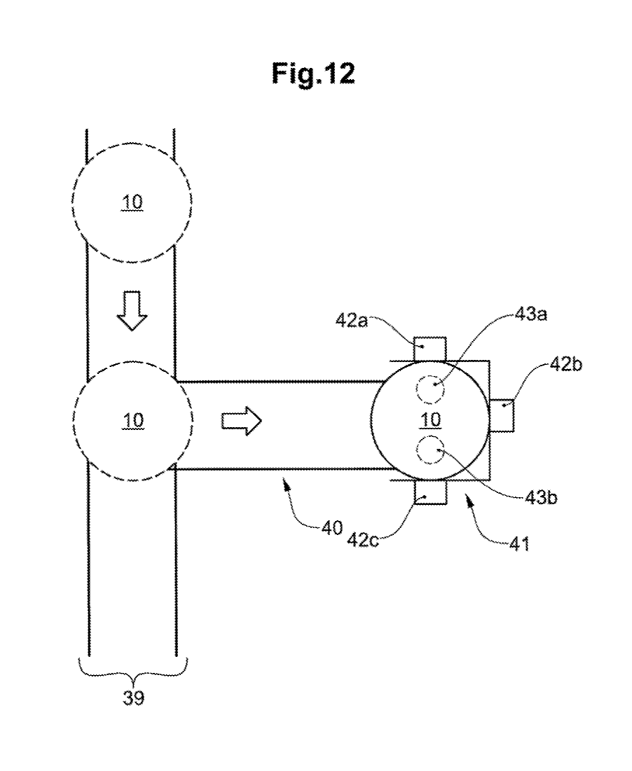

In addition to the usable volume 13, which is to be kept open for accommodating the products or goods, an energy store 14 and an energy consumer 15 are accommodated in the rolling body 10a, both of which are depicted as schematic blocks in FIG. 1 but which may also have some other shape, for example a shape that is divided into multiple parts. The energy store 14 stores energy, which may be requested by the energy consumer 15 as needed. The energy store 14 is hereby discharged, and after a certain period of time must either be replaced by a fully charged energy store of the same type (key word “battery change”) or externally charged. The various types of charging are discussed in greater detail below. As mentioned above, the energy store 14 may be divided into energy stores 14a and 14b (depicted by dashed lines in FIG. 12). However, the energy stores 14a and 14b may also be additionally provided, so that three energy stores 14, 14a, and 14b are present. The basis of such a measure is to achieve a better distribution of the masses inside the shell 11 in order to bring the center of gravity SP of the system as close as possible to the midpoint of the sphere, as indicated in FIG. 1. Such a position of the center of gravity SP prevents undesirable tumbling motions from arising when the rolling body is rolling. Of course, besides the energy consumer 15, it is possible to use a product, situated in the usable volume 13, for optimizing the location of the center of gravity.

In most cases the energy store 14 is designed as an electrical energy store that contains electrical energy and delivers it to an electrical energy consumer 15. In this case, a so-called supercapacitor or a rechargeable accumulator having sufficient storage capacity, such as the lithium-ion type, is conceivable as an energy store. A supercapacitor is adequate when the energy consumer 15 includes only one electronic circuit for data processing, position finding, or communication. If the energy consumer is a motorized drive for the rolling body, an accumulator having sufficient capacity must be provided as an energy store. However, it is also conceivable to use only one buffer store (a “standard” capacitor, for example) as an energy store when the energy consumption is to be continuously compensated for on average by external recharging.

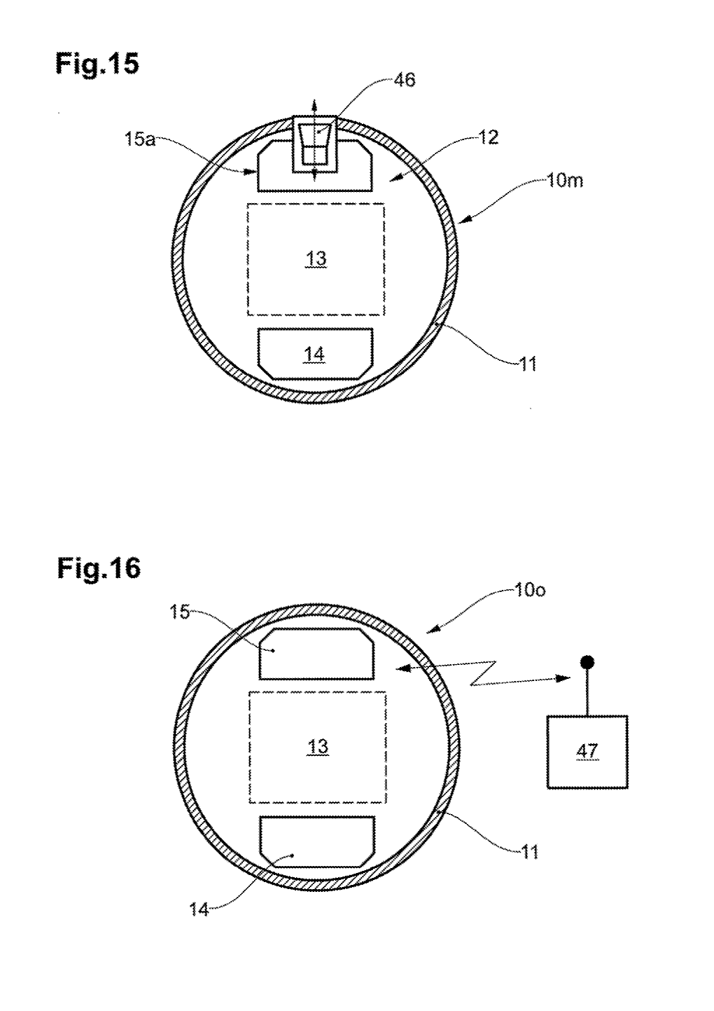

To be able to carry out an operation with the rolling bodies in the easiest possible manner and without interruptions, it is practical and advantageous to put the energy store 14 under load only when actually necessary, and otherwise, for example when the rolling body is in a resting or waiting position in a warehouse, to preferably leave it free of load. It is useful here to provide a standby mode in the rolling body, in which the energy store 14 is put under load only when necessary in order to keep the rolling body ready for a subsequent activation. Such an activation may take place via radio signals, for example (see FIG. 16), but requires that the corresponding electronics system in the rolling body at least be externally accessible.

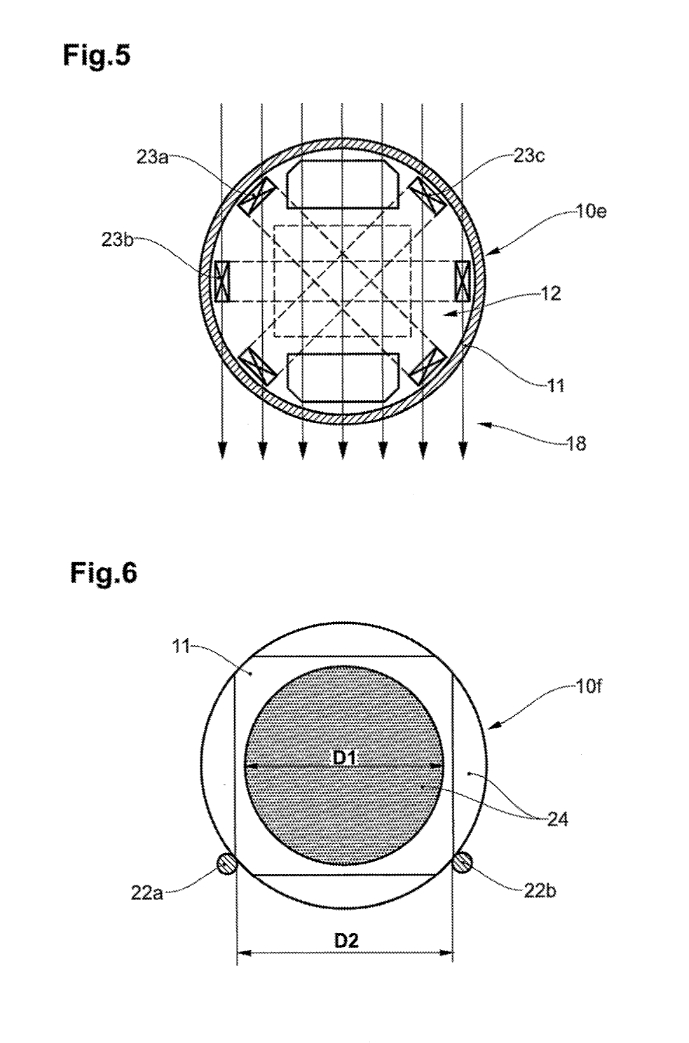

A first option for externally recharging an electrical energy store 14 is schematically illustrated in FIG. 2. An induction coil 16 through which an externally generated magnetic field 18 may pass by means of a magnetic field source 17 is situated in the rolling body 10b shown, preferably in the vicinity of the energy store 14. The change in the associated magnetic flux due to the induction coil induces a current in the induction coil 16 which may be stored in the form of charge in the energy store 15. The change in the flux may be produced by using an alternating magnetic field. However, it is also conceivable to use a constant field if the change in flux due to a movement of the rolling body 10b is sufficiently great. In this case, according to FIG. 5, for a rolling body 10e a plurality of induction coils 23a-c having different spatial orientations may ensure that magnetic flux always passes through one or more coils. The induction coils 23a-c may even be integrated into the shell 11 of the rolling body 10e, and when synthetic resin is used, may be employed as a type of fiber reinforcement in order to additionally stabilize the shell 11.

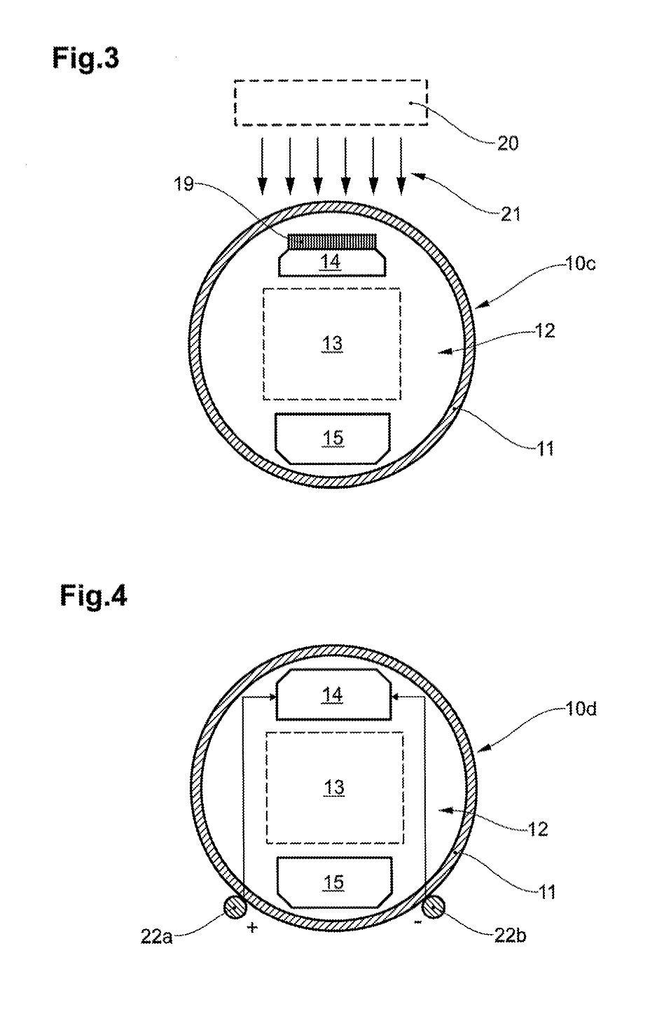

Another type of charging of an electrical energy store 14 is schematically shown in FIG. 3. In the rolling body 10c shown there, a flat light converter 19 is provided which converts external incident light 21 from a light source 20 (sunlight or artificially generated light) into electrical energy and relays it to the energy store 14. For this purpose, at least the portion of the shell 11 above the light converter 19 must have a light-permeable design. This may be achieved by appropriate openings in a shell that is otherwise impermeable to light (see FIG. 3). However, it is also conceivable to provide the shell 11 with a light-permeable (transparent) design at this location, or as a whole.

Another possible type of charging is shown in the diagram in FIG. 4. The rolling body 10d shown there is equipped with externally accessible electrical contact surfaces (not visible in FIG. 4), with which an external electrical connection may be established via corresponding electrical contacts 22a and 22b. In the case of contact, electrical energy may be fed into the energy store 14, using direct voltage or alternating voltage. It is understood, of course, that an electronics system (rectifier, regulators, overvoltage protection, etc.) possibly necessary for this purpose is installed in the rolling body 10d.

A special case of external contacting is illustrated in FIG. 6. The spherical rolling body 10f in FIG. 6 is equipped on the outside with (a total of six) dome-shaped electrical contact surfaces 24, all of which have the same maximum diameter D1. Oppositely situated therefrom are two tracks, as electrical contacts 22a and 22b, extending perpendicularly with respect to the plane of the drawing, and on which the rolling body 10f can roll in the longitudinal direction of the tracks. The distance D2 between the tracks 22a, 22b is selected to be greater than the maximum diameter D1 of the domed surfaces 24. When the rolling body rolls on the tracks, on account of the condition D1<D2 the contacts 22a and 22b cannot be short-circuited by the contact surfaces 24. In contrast, usually two different, changing contact surfaces 24 are in electrical connection with the contacts 22a and 22b. If the two contact surfaces 24 at which the voltage of the contacts 22a and 22b is present are always connected at the moment to the energy store 14 by an internal electronics system, the energy store may be charged over long segments of the rolling path. In this regard, it is also conceivable to provide fewer (at least two, or more) contact surfaces, provided that a short circuit of the external contacts is reliably avoided.

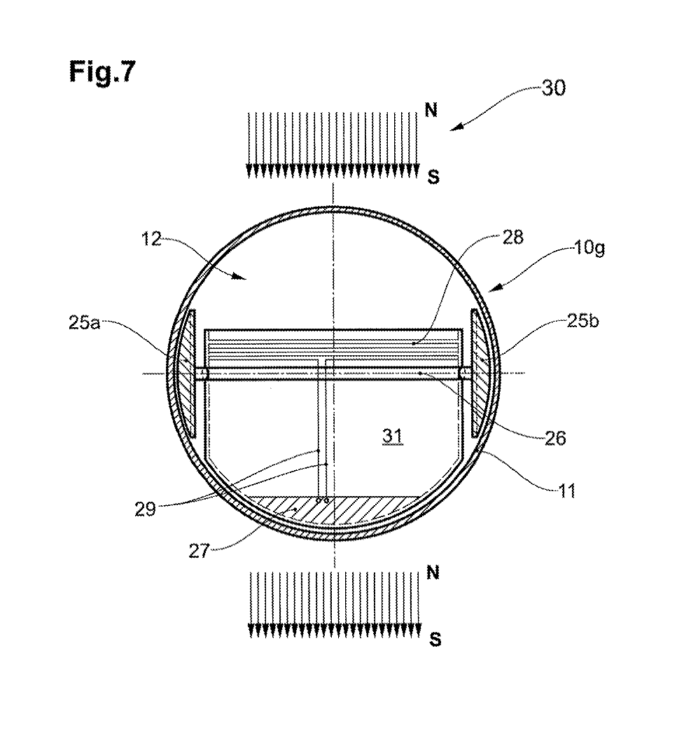

Another exemplary embodiment for a rolling body according to the invention is shown in FIG. 7. The rolling body 10g shown there has an insert 31 that always hangs downwardly by means of a rotational axis 26 supported in lateral bearing elements 25a and 25b, so that a heavy storage element 27 is situated in the lower area. The induction coil 28 situated above the rotational axis 26 then has a certain orientation with respect to an external magnetic field 30, which as an alternating field induces a voltage that may be applied via connecting lines 29 to the storage element 27 in order to charge it.

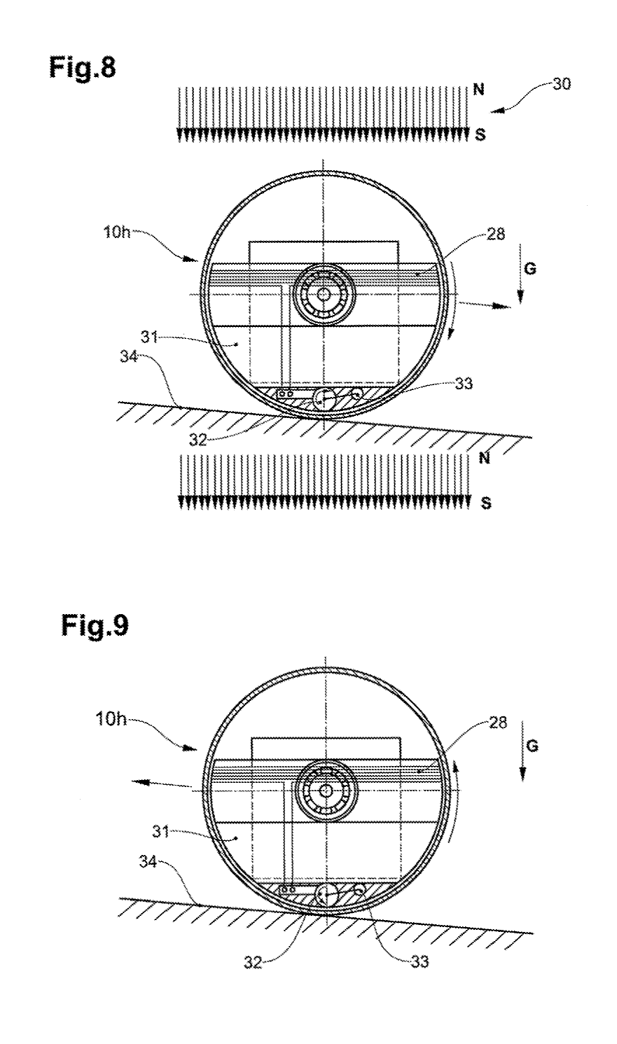

According to FIGS. 8 and 9, a comparable arrangement in a rolling body 10h may be combined with an internal drive having a drive element 32 which runs with frictional engagement on the inner wall of the shell, and which is driven by an (electric) motor 33. In the case of FIG. 8, the rolling body 10h rolls downhill on a slope 34 due to the force of gravity G, and may thereby be charged with energy via the magnetic field 30. In the case of FIG. 9, the rolling body 10h autonomously travels uphill on the slope, with consumption of energy, and is driven by the motor 33.

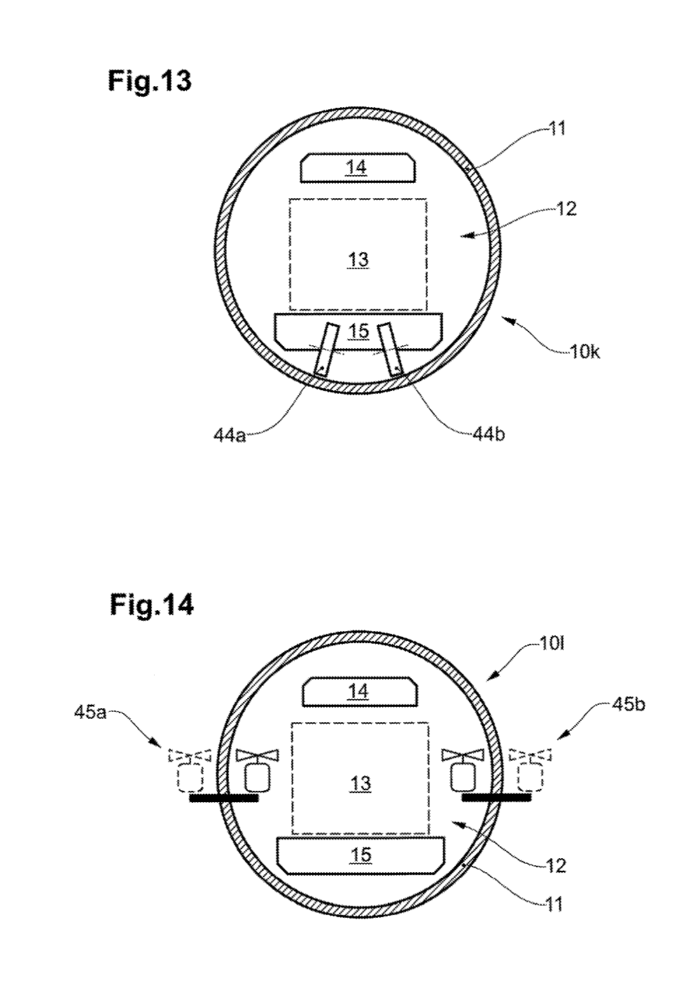

When according to FIG. 13 two spaced-apart drive wheels 44a and 44b, perpendicular to the shell 11, are used in a rolling body 10k, the rolling body 10k may be autonomously rolled in any desired direction by different operation of the two drive wheels 44a and 44b in the manner of an armored tank crawler track control system. For a rolling body that rolls down a slope under the force of gravity (see FIG. 8), these types of internal drives may also be used to recover energy by recuperation and store it in the energy store, provided that the drive motor or the drive motors can operate as generator(s) that are coupled via the frictional engagement.

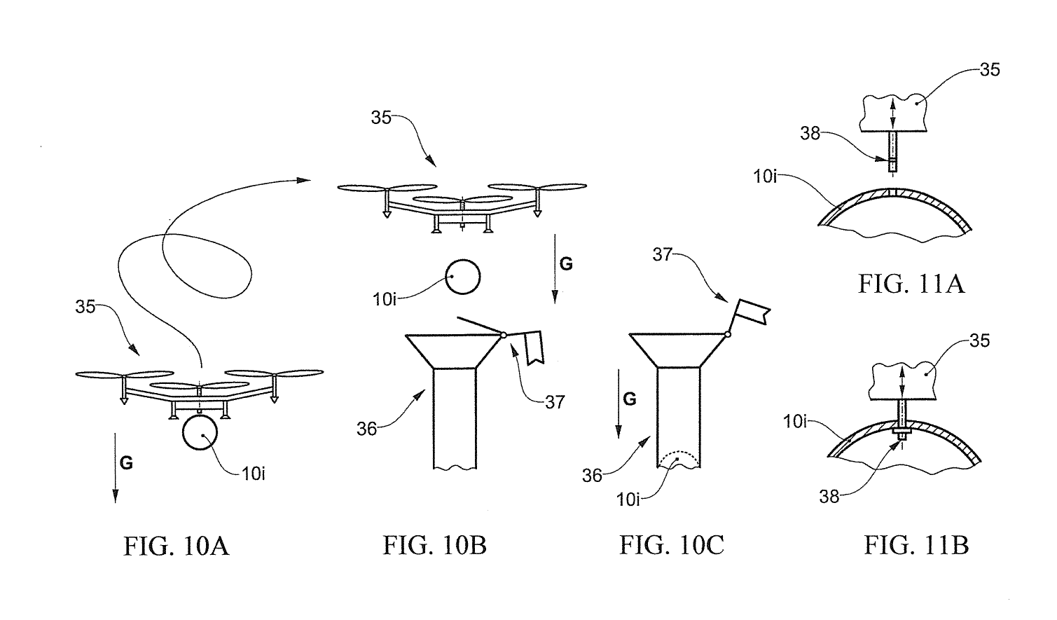

If no independent drive is provided in the rolling body, or if an existing roller drive of the type shown in FIGS. 8 and 9 is not used, according to FIGS. 10 and 11 a rolling body 10i (together with product content in question) may also be transported by external transport means. In the case shown, for this purpose a drone 35, for example, is used which couples to the rolling body 10i (FIG. 10(a)), conveys the rolling body 10i together with its contents to a destination point (FIG. 10(b)), and automatically unloads at that location. For this purpose, a funnel-shaped receiving device 36, as a “mailbox,” may be provided which receives the dropped rolling body 10i and optionally further conveys and/or distributes it and indicates the receipt by means of a signal device 37 (FIG. 10(c)). For the coupling, the drone 35 may be equipped with a pin-shaped coupling element 38 (FIG. 11(a)) that retracts into a corresponding opening in the shell of the rolling body 10i, and is locked in the retracted state (FIG. 11(b)). The opening advantageously has a funnel-shaped design (not shown in FIG. 11(b)) in order to facilitate the insertion. In this regard, the advantage of the rolling body is that it has a streamlined shape that facilitates the air transport, and that, due to the spherical shape, it is able to more easily pass into the receiving device 36 after being dropped. This type of transport and delivery of the rolling bodies is not only advantageous within the scope of the present invention for “active” rolling bodies having energy stores and energy consumers, but may also be used as an advantageous approach for “passive” rolling bodies without energy stores or energy consumers.

In this regard, for a rolling body 10m according to FIG. 15, an automatically extendable coupling mechanism 46 may be provided in the rolling body itself, inside the energy consumer 15a; the coupling mechanism automatically moves out of the sphere (double arrow) upon request by a drone or the like, and passively allows docking with the drone or even actively carries this out itself. At the same time, this extendable coupling mechanism 46 may also be designed as an electrical charging coupler for charging the energy store 14, and may cooperate with corresponding external contacts.

According to FIG. 14, however, it is also conceivable to equip a rolling body 101 itself with appropriate propeller units 45a and 45b, which during a rolling movement of the rolling body 101 are retracted in the rolling body 101 (solid-line drawing in FIG. 14), but which for the transition to drone operation may be extended (dashed-line portion in FIG. 14).

Within the scope of the invention, according to FIG. 12 it is also conceivable to provide a separate charging station 41 in a device that operates with rolling paths 39 for the rolling bodies 10, the charging station being designed, for example, as a branch 40 from the rolling path 39. The rolling body 10 to be charged is deflected (by a switching or ejecting mechanism, not shown) from the rolling path 39 into the branch 40 and passes into the charging station 41. Rotary drives 42a-c, distributed at that location, allow the rolling body 10 to rotate in the charging station into a position such that contact points 43a and 43b situated on the rolling body are connected to corresponding contacts in the charging station 41, so that a charging operation may be started.

The operation of the described rolling bodies may have a different design:

Within the scope of the invention, it is conceivable for the energy store to be replaceably housed in the rolling body, and for the energy store to be replaced with a full energy store from time to time. For this purpose, conventional batteries, for example, may be used as the energy store.

Alternatively, the energy store in the rolling body may be permanently housed. It is then externally charged from time to time, it being possible to use the charging options described above.

When the rolling body has one or more induction coils, the rolling body is exposed to a magnetic field in order to charge the energy store, whereby the magnetic field may be an alternating field.

However, the rolling body may also have externally accessible electrical contacts. It is then electrically connected to external electrical contacts in order to charge the energy store. This may take place in the charging station, described above, provided for this purpose. However, it is also conceivable to electrically connect the rolling body to external electrical contacts and keep it connected while it is rolling over a predefined route.

If the rolling body according to the invention is to autonomously carry out certain tasks, the necessary commands, in particular for changing from a standby mode into an active mode, may be transmitted to it via a wireless communication link. According to FIG. 16, the rolling body 10o is then wirelessly connected from the appropriate configured energy consumer 15 to a communication center 47, which on the one hand may transmit commands and/or information and/or requests to the rolling body 10o, but which on the other hand may also respond to information from the rolling body, for example concerning the state of charge of the energy store 14 or the product that is being kept in the usable volume 13. To allow the wireless communication, an antenna may be externally mounted, or, if the shell is permeable for the wireless connection, may be internally mounted.

In addition, the rolling body 10 may be equipped with active or passive information carriers or identification means such as a label, RFID, barcode, matrix code, color code, numerical code, hologram, or thermal code that may be read out and optionally read in by optical, magnetic, or radio-based means.

Motorized drives as well as electronic circuits, data memories, and/or processors for data processing, for example microprocessors, may be provided within the energy consumer 15, as described. Furthermore, sensors for physical variables such as temperature or acceleration, and/or converters, for example piezoelectric converters, pneumatic converters, inductive converters, or electromagnetic converters, may be used in the rolling body for various tasks.

It is also possible to provide in the rolling body a data processing system, having a data memory, which receives, processes, and delivers product information concerning products that are introduced/transported in the rolling body, such as weight, use-by date, expiration date, production date, number/quantity information, state of ripeness, target temperature, temperature history, tracking number, transport order number, status information, and information concerning product geometry.

It is conceivable to carry out computing operations in the data processing system, using the product data and information concerning position, conveying path of the rolling body, and other external parameters, and as a result of these computing operations, to control electromechanical actuators which determine the further path of the rolling body in a storage or transport facility.

The present invention is not to be limited in scope by the specific embodiments described herein. Indeed, various modifications of the present invention, in addition to those described herein, will be apparent to those skilled in the art from the foregoing description and accompanying drawings. Thus, such modifications are intended to fall within the scope of the appended claims. Additionally, various references are cited throughout the specification, the disclosures of which are each incorporated herein by reference in their entirety.

1. A rolling body (10; 10a-o) for temporarily accommodating goods or products for the purpose of storage and/or transport, the rolling body (10; 10a-l) comprising:
a shell (11) that encloses an inner space (12), a usable volume (13) for accommodating the goods being provided in the inner space (12);
an energy store (14, 27) and an energy consumer (15, 33) situated in the inner space (12), wherein the energy store (14, 27) is connectable to the energy consumer (15, 33) in order to deliver energy.

2. The rolling body according to claim 1, wherein the energy store (14, 27) is designed for storing electrical energy, and the energy consumer (15, 33) consumes electrical energy.

3. The rolling body according to claim 2, further comprising:
means (16; 19; 22a, b; 23a-c; 24; 28; 43a, b) for supplying electrical energy from the outside provided on or in the rolling body (10; 10a-o), and wherein the means (16; 19; 22a, b; 23a-c; 24; 28; 43a, b) are connected to the energy store (14, 27).

4. The rolling body according to claim 3, wherein the means (16; 19; 22a, b; 23a-c; 24; 28; 43a, b) for supplying electrical energy include one or more induction coils (16; 23a-c; 28).

5. The rolling body according to claim 4, wherein multiple induction coils (23a-c) are provided, each having a coil axis oriented in a different spatial direction.

6. The rolling body according to claim 3, wherein the means (16; 19; 22a, b; 23a-c; 24; 28; 43a, b) for supplying electrical energy include externally accessible electrical contacts (22a, b; 43a, b).

7. The rolling body according to claim 6, wherein the electrical contacts (24) are distributed over the outer surface of the rolling body (10f).

8. The rolling body according to claim 7, wherein the rolling body (10f) is spherical, and the electrical contacts (24) have a dome-shaped design.

9. The rolling body according to claim 3, wherein the means (16; 19; 22a, b; 23a-c; 24; 28; 43a, b) for supplying electrical energy include at least one light converter (19), which converts light irradiated from the outside into electrical energy.

10. The rolling body according to claim 1, wherein the energy consumer (15, 33) includes a drive (32, 33; 44a, b; 45a, b) for autonomously moving the rolling body (10h; 10k; 10l).

11. The rolling body according to claim 10, wherein the drive includes at least one electric motor (33) that sets at least one drive element (32; 44a, b) in rotation, for transmitting a torque.

12. The rolling body according to claim 10, wherein the drive includes at least one propeller unit (45a, b).

13. The rolling body according to claim 1, wherein the energy consumer (15) includes means for data processing and/or data storage, and/or means for wireless communication and/or means for determining the position of the rolling body (10; 10a-o).

14. A method for operating a rolling body (10; 10a-l) according to claim 1, wherein the energy store (14) is replaceably housed in the rolling body, and wherein from time to time the energy store (14) is replaced with a full energy store.

15. The method for operating a rolling body (10; 10a-o) according to claim 1, wherein the energy store (14; 27) is permanently housed in the rolling body, and wherein from time to time the energy store (14; 27) is charged from the outside.

16. The method according to claim 15, wherein the rolling body (10b; 10e; 10g; 10h) includes at least one induction coil (16; 23a-c; 28), and the rolling body (10b; 10e; 10g; 10h) is exposed to a magnetic field (18, 30) in order to charge the energy store (14; 27).

17. The method according to claim 16, wherein the magnetic field (18, 30) is an alternating field.

18. The method according to claim 15, wherein the rolling body (10; 10d; 10f) includes externally accessible electrical contacts (22a, b; 43a, b), and the rolling body (10; 10d; 10f) is electrically connected to external electrical contacts (22a, b) in order to charge the energy store (14).

19. The method according to claim 18, wherein the rolling body (10) is moved into a charging station (41), provided for this purpose, in order to connect to the external electrical contacts.

20. The method according to claim 18, wherein the rolling body (10d) is electrically connected, and remains connected, to the external electrical contacts (22a, b) while rolling over a predefined route.
